(19) United States
(12) Patent Application Publication
(10) Pub. No.: US 2011/0176440 A1
(43) Pub. Date: Jul. 21, 2011

(54) RESTRICTIONS ON AUTONOMOUS MUTING TO ENABLE TIME DIFFERENCE OF ARRIVAL MEASUREMENTS

(75) Inventors: Colin D. Frank, Park Ridge, IL (US); Sandeep H. Krishnamurthy, Arlington Heights, IL (US)

(73) Assignee: MOTOROLA-MOBILITY, INC., Libertyville, IL (US)

(21) Appl. No.: 12/973,467

(22) Filed: Dec. 20, 2010

Related U.S. Application Data
(60) Provisional application No. 61/295,678, filed on Jan. 15, 2010.

(51) Int. Cl. H04L 12/26

(52) U.S. Cl. 370/252

(57) ABSTRACT

A mobile terminal receives a transmission from a base station including a group of Nprs consecutive subframes, where Nprs is a number of subframes constituting the group, and each subframe is capable of transmitting a positioning reference signal (PRS). The group of Nprs consecutive subframes is configured such that a transition between a subframe that does, or does not, include a PRS transmission to a subsequent subframe that does not, or does, include a PRS transmission can occur only after an even number of subframes 2*k, where k=0, 1, 2 . . . . The mobile terminal determines an estimated time of arrival of the transmission from the base station based on a portion of the transmission that includes a PRS transmission.

### CROSS REFERENCE TO RELATED APPLICATIONS

The present application is a non-provisional application of U.S. provisional Application No. 61/295,678 filed on 15 Jan. 2010, the contents of which are incorporated herein by reference and from which benefits are claimed under 35 U.S.C. 119.

### FIELD OF THE DISCLOSURE

The present disclosure relates generally to wireless communications and, more particularly, to methods and systems for mitigating interference at a mobile station in a coordinated wireless communication network when making measurements for determining the position of the mobile station based on time difference of arrival measurements.

### BACKGROUND

The Third Generation Partnership Project (3GPP) is developing a Long Term Evolution (LTE) wireless communication standard using a physical layer based on globally applicable Evolved Universal Terrestrial Radio Access (E-UTRA). In the LTE Release-8 (Rel-8) specification, an LTE base station, referred to as an enhanced Node-B (eNB), may use an antenna array of up to four antennas to broadcast a signal to a piece of user equipment.

A user communication device, or user equipment (UE), may rely on a pilot or reference symbol (RS) sent from the eNB transmitter for channel estimation, subsequent data demodulation, and link quality measurement for reporting. Beginning with LTE Rel-9, the UE may rely on a positioning reference symbol (PRS) to determine an observed time difference of arrival (OTDOA) of the PRS from one or more network base stations. The UE device may send the OTDOA to the network. The network may use that data to calculate an approximate position of the UE within the network by calculating by triangulation based on distances between the UE device and several network base stations.

The various aspects, features and advantages of the disclosure will become more fully apparent to those having ordinary skill in the art upon careful consideration of the following Detailed Description and the accompanying drawings described below. The drawings may have been simplified for clarity and are not necessarily drawn to scale.

### BRIEF DESCRIPTION OF THE DRAWINGS

Understanding that these drawings depict only typical embodiments of the invention and are not therefore to be considered to be limiting of its scope, the disclosure will be described and explained with additional specificity and detail through the use of the accompanying drawings in which:

FIG. 1 illustrates in a block diagram one embodiment of a communication system.

FIG. 2 illustrates a possible configuration of a computing system to act as a base transceiver station.

FIG. 3 illustrates in a block diagram one embodiment of a mobile system or electronic device to create a radio connection.

FIG. 4A-4B illustrate in a block diagram different embodiments of a resource block of a positioning subframe.

FIG. 5 illustrates in a block diagram one embodiment of a system information block.

FIG. 6A illustrates a schematic diagram of the transmission of PRS from a first eNB over 6 subframes configured for PRS transmission without restrictions on autonomous muting.

FIG. 6B illustrates a schematic diagram of the transmission of PRS from a second eNB over 6 subframes configured for PRS transmission with restrictions.

FIG. 7 illustrates a process flow diagram in a mobile terminal.

### DETAILED DESCRIPTION

A method, a user communication device, and a base station are disclosed. A transceiver may receive a serving transmission from a serving base station. A processor may make a status determination of an autonomous muting status of a neighbor base station based on the serving transmission.

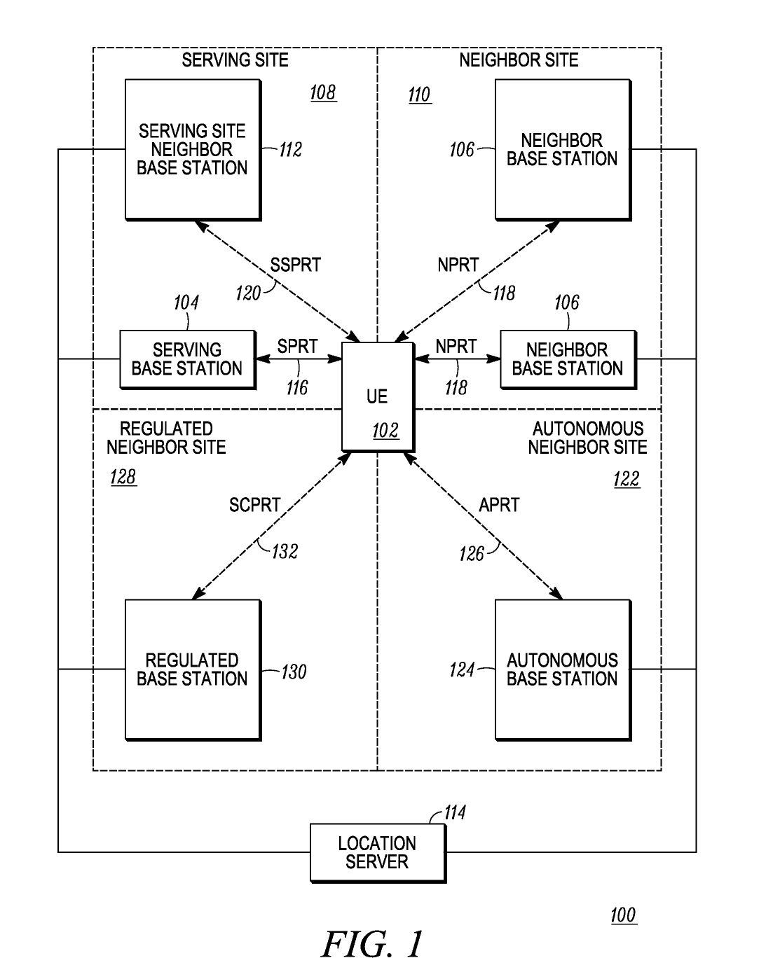

FIG. 1 illustrates one embodiment of a communication network 100. While a Long Term Evolution (LTE) carrier communication system 100, as defined by the Third Generation Partnership Project (3GPP®) is disclosed, other types of communication systems may use the present invention. Various communication devices may exchange data or information through the network 100. The network 100 may be an evolved universal terrestrial radio access (E-UTRA), or other type of telecommunication network.

A LTE user equipment (UE) device 102, or user communication device, may access the coordinated communication network 100 via any one of a number of LTE network base stations, or enhance Node Bs (eNB), that support the network. For one embodiment, the UE device 102 may be one of several types of handheld or mobile devices, such as, a mobile phone, a laptop, or a personal digital assistant (PDA). For one embodiment, the UE device 102 may be a WiFi® capable device, a WiMAX® capable device, or other wireless devices.

The primary network base station currently connecting the UE device 102 to the coordinated communications network may be referred to as a serving base station 104. The UE device 102 may receive signals from other network base stations proximate to the serving base station 104, referred to herein as a neighbor base station 106.

A cellular site may have multiple base stations. A cellular site having the serving base station 104 may be referred to herein as the serving site 108. A cellular site that does not have the serving base station 104 may be referred to herein as the neighbor site 110. A serving site 108 may also have one or more neighbor base stations in addition to the serving network base station 108, referred to herein as a serving site neighbor base station 112.

The coordinated communication network 100 may use a location server 114 to triangulate the network location of the UE device 102 within the coordinated communication network 100. Alternatively, one of the base stations may act as a location server 114. Each base station may broadcast a positioning reference transmission to be received by the UE device 102. The location server 114 may use the positioning reference transmission to determine the location of the UE device 102 within the network 100. Alternately, the UE device 102 or the serving base station 104 may use the positioning reference transmission to determine the location. The positioning reference transmission may be a set of one or more positioning reference symbols (PRS) of various values arranged in a pattern unique to the base station sending the positioning reference transmission.

The positioning reference transmission from the serving base station 104 may be referred to herein as the serving positioning reference transmission (SPRT) 116. The positioning reference transmission from the neighbor base station 106 may be referred to herein as the neighbor positioning reference transmission (NPRT) 118. The positioning reference transmission from the serving site neighbor base station 112 may be referred to herein as a same site positioning reference transmission (SSPRT) 120. The UE device 102 may measure the observed time difference of arrival (OTDOA) for each NPRT 118, to determine the distance between the UE device 102 and each observed neighbor base station 106.

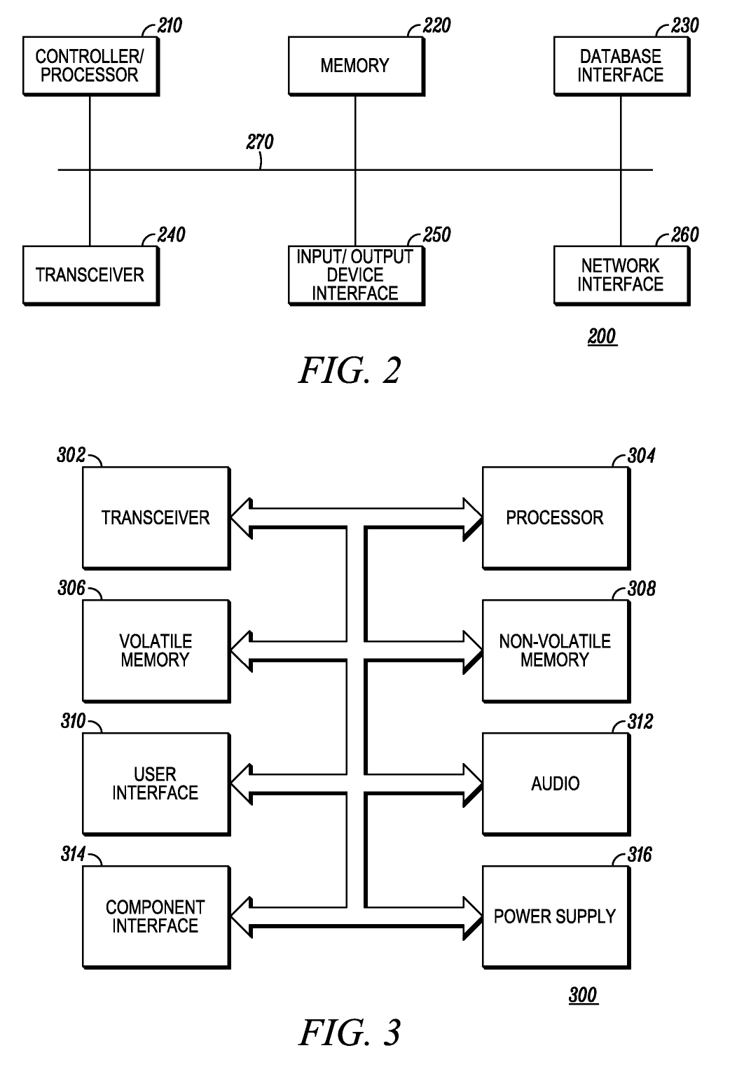

FIG. 2 illustrates a possible configuration of a computing system 200 to act as a network operator server 106 or a home network base station 110. The computing system 200 may include a controller/processor 210, a memory 220, a database interface 230, a transceiver 240, input/output (I/O) device interface 250, and a network interface 260, connected through bus 270. The network server 200 may implement any operating system. Client and server software may be written in any programming language, such as C, C++, Java or Visual Basic, for example. The server software may run on an application framework, such as, for example, a Java® server or .NET® framework.

The controller/processor 210 may be any programmed processor known to one of skill in the art. However, the method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the method as described herein may be used to implement the system functions of this invention.

The memory 220 may include volatile and nonvolatile data storage, including one or more electrical, magnetic or optical memories such as a random access memory (RAM), cache, hard drive, or other memory device. The memory may have a cache to speed access to specific data. The memory 220 may also be connected to a compact disc-read only memory (CD-ROM), digital video disc-read only memory (DVD-ROM), DVD read write input, tape drive, or other removable memory device that allows media content to be directly uploaded into the system.

Data may be stored in the memory or in a separate database. The database interface 230 may be used by the controller/processor 210 to access the database. The database may contain a subscriber information set for each UE device 102 that may access the network 100, as well as a physical cell identifier (PCID) for the base station.

The transceiver 240 may create a connection with the mobile device 104. The transceiver 240 may be incorporated into a base station 200 or may be a separate device.

The I/O device interface 250 may be connected to one or more input devices that may include a keyboard, mouse, pen-operated touch screen or monitor, voice-recognition device, or any other device that accepts input. The I/O device interface 250 may also be connected to one or more output devices, such as a monitor, printer, disk drive, speakers, or any other device provided to output data. The I/O device interface 250 may receive a data task or connection criteria from a network administrator.

The network connection interface 260 may be connected to a communication device, modem, network interface card, a transceiver, or any other device capable of transmitting and receiving signals from the network. The network connection interface 260 may be used to connect a client device to a network. The network interface 260 may connect the home network base station 110 to a mobility management entity of the network operator server 106. The components of the network server 200 may be connected via an electrical bus 270, for example, or linked wirelessly.

Client software and databases may be accessed by the controller/processor 210 from memory 220, and may include, for example, database applications, word processing applications, as well as components that embody the functionality of the present invention. The network server 200 may implement any operating system. Client and server software may be written in any programming language. Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

FIG. 3 illustrates one embodiment of a mobile device 300, capable of acting as a UE device 102 or user communication device. For some embodiments of the present invention, the mobile device 300 may also support one or more applications for performing various communications with a network. The mobile device 300 may be a handheld device, such as, a mobile phone, a laptop, or a personal digital assistant (PDA). For some embodiments of the present invention, the user device 300 may be WiFi® capable device, which may be used to access the network mobile for data or by voice using VOIP.

The mobile device 300 may include a transceiver 302, which is capable of sending and receiving data over the mobile network 102. The mobile device 300 may include a processor 304 that executes stored programs. The mobile device 300 may also include a volatile memory 306 and a non-volatile memory 308 to act as data storage for the processor 304. The mobile device 300 may include a user input interface 310 that may comprise elements such as a keypad, display, touch screen, and the like. The mobile device 300 may also include a user output device that may comprise a display screen and an audio interface 312 that may comprise elements such as a microphone, earphone, and speaker. The mobile device 300 also may include a component interface 314 to which additional elements may be attached, for example, a universal serial bus (USB) interface. Finally, the mobile device 300 may include a power supply 316.

In order to determine the position of the UE device 102 within the coordinated communication network 100, the UE device 102 may make time-difference-of-arrival measurements based on transmissions from neighboring network base stations 106. The UE device 102 may use positioning subframes and positioning reference symbols to better “hear” neighbor base stations 106.

As each base station sends a different positioning reference transmission, the positioning reference symbols may become interlaced in the frequency domain. Each base station may apply one of a set of frequency offsets, for example, a set of six frequency offsets, to better distinguish between the base stations. As a coordinated communication network 100 may have more base stations than frequency offsets, multiple base stations may be assigned the same offset. For example, if the network 100 has eighteen base stations and uses six frequency offsets, each frequency offset may be assigned to three base stations.

Depending on the bandwidth of the system, the positioning subframe may contain any number of resource blocks, such as six to one hundred resource blocks. The resource block may have, for example, twelve to fourteen symbols and twelve subcarriers. For a largest bandwidth of 20 MHz, the positioning subframe may have, for example, one hundred resource blocks, and thus 1200 subcarriers per subframe. The resource blocks may be stacked in frequency. Thus, for every symbol within the subframe, the subframe may have, for example, 1200 subcarriers.

In one embodiment, a set of diagonal PRS patterns is defined for use in the positioning subframes. The patterns may be frequency offsets of a base diagonal pattern with the cell-specific frequency shift given by v_{shift}=N_{Cell}^{ID}mod 6.

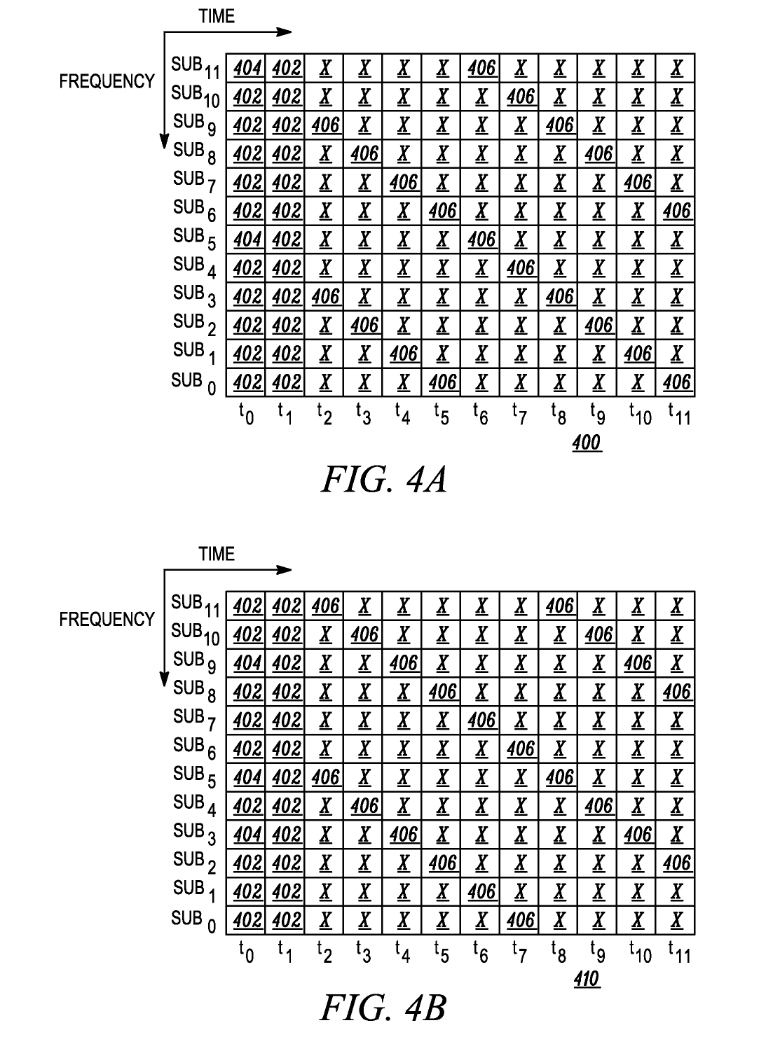

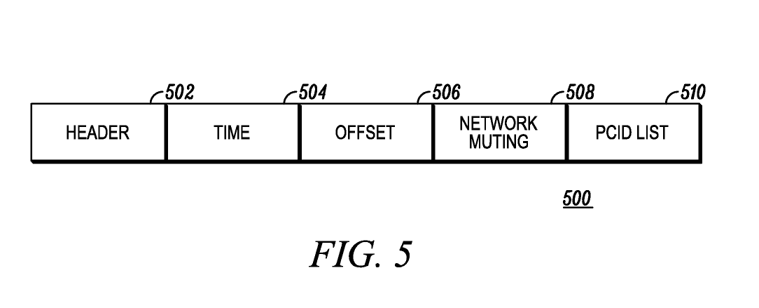

Different resource blocks may represent different base stations. FIG. 4A illustrates, in a block diagram, one embodiment of a resource block 400 from a first base station, while FIG. 4b illustrates, in a block diagram, one embodiment of a resource block 410 from a second base station. The positioning subframe may have both a time component and a frequency component. Each resource block 400 may begin with a set of control region symbols 402. The resource block 400 may have a common reference symbol representing an antenna port. One or more positioning reference symbols 406 may be encoded in the positioning subframe in a pattern. A UE device may use both the pattern and the values of the positioning reference symbols 406 to identify the originating base station.

Even with the inclusion of positioning reference symbols 406, a UE device 102 near a serving base station 104 may have significant difficulty in measuring the OTDOA of a neighbor base station 106 for multiple reasons. One reason may be the adaptive gain control or analog to digital converter limitations in the receiver. If the UE device is near the serving base station 104, the power of the serving base station 104 may far exceed that of the neighbor base station to be measured. As a result of these dynamic range limitations in the UE device 102, the UE device 102 may not be able to take measurements on a sufficient number of neighbor base stations 106 to enable an accurate position fix.

A second reason may be the misalignment of the positioning reference symbol (PRS) pattern. The PRS patterns may be orthogonal in the frequency domain. However, if two base stations are assigned orthogonal PRS patterns, the orthogonal nature of the corresponding positioning reference transmission signals received by the UE device may depend on the positioning reference transmission signals being properly aligned as observed by the UE device. The positioning reference transmission signals may be considered properly aligned if the sum of the OTDOA and the channel delay spread do not exceed the cyclic prefix. Otherwise, the positioning reference transmission signals received by the UE device may not be orthogonal even if the PRS patterns are. If a neighbor base station is assigned a different pattern than the serving base station, the UE device may make an OTDOA measurement on the neighbor base station without interference from the serving base station, assuming no adaptive gain control or analog to digital converter limitations. However, if the sum of the OTDOA and the channel delay spread exceed the channel cyclic prefix, the OTDOA measurements may be contaminated with interference from the serving base station, which may be very strong when the UE device is near the serving base station.

In a partially synchronous network, the positioning subframes from different base stations may be offset by as much as one-half a subframe or more, resulting in misalignment of the symbol boundaries. Thus, the PRS patterns which are orthogonal in the frequency domain when the positioning subframes are time aligned may no longer be orthogonal, regardless of the channel delay-spread or the OTDOA of the serving base station and the neighbor base stations.

One solution to the above problems is to sometimes mute the serving base station in order to enable the UE device to take accurate OTDOA measurements on a sufficient number of neighbor base stations when the UE device is near the serving base station.

The base station may transmit the positioning reference transmission with zero power in certain positioning subframes, or mute certain positioning subframes. However, the UE device may currently be unaware of whether or not a particular base station has muted its positioning reference transmission, leading to problems when the positioning reference transmission from a neighbour base station is sufficiently weak to prevent a reliable determination of whether or not the positioning reference transmission were transmitted by a particular base station, and thus whether or not the OTDOA measurement for the base station is valid.

A base station may perform this muting of the position reference transmission autonomously. Referring to FIG. 1, a neighbor site 110 that allows one of its base stations to autonomously mute the position reference transmission may be referred to herein as an autonomous neighbor site 122. A base station on an autonomous neighbor site 122 may be referred to as an autonomous base station 124. The position reference transmission sent by the autonomous base station 124 may be referred to as an autonomous position reference transmission (APRT) 126. Similarly, a scheduled neighbor site 128 may forgo muting or may mute the position reference transmission following a scheduled pattern known to the UE device 102. A base station on a scheduled neighbor site 128 may be referred to as a scheduled base station 130. The position reference transmission sent by the scheduled base station 130 may be referred to as a scheduled position reference transmission (SCPRT) 132. The present disclosure is concerned with base stations employing autonomous muting to enable APRT.

As mentioned earlier, for a UE near the serving cell, strong serving cell interference can prevent the UE from taking accurate measurements of the time difference of arrival of signals from the neighboring cells, or at least, from taking TDOA measurements from a sufficient number of neighboring cells in order to take an accurate measurement.

To a large extent, the interference from the serving cell is mitigated in the synchronous case due to the fact that the positioning reference symbols assigned to the eNB's may belong to 1 of 6 orthogonal PRS patterns. Thus, for any neighbor that is assigned a PRS pattern other than that assigned to the serving cell, the interference of the serving cell is largely orthogonal to signal of interest from the neighboring cell. However, as mentioned earlier, there are circumstances where there can be a loss of orthogonality including the following cases:

Where the sum of the channel delay spread and the time difference of arrival between the serving cell and the neighbor cell exceeds the delay spread of the channel; and

Where there is not full alignment between the serving cells and the positioning cells. This is the so-called partial alignment case originally illustrated in 3GPP contribution R1-091312.

In the second of the two cases, the interference from the serving cell into a neighbor cell OTDOA measurement can be very strong, even in the event that the orthogonal PRS patterns are assigned to the serving cell and the neighbor cell. This problem has been demonstrated in 3GPP contribution R1-092628.

One way to mitigate this interference is to occasionally mute the serving cell. The muting can either be scheduled in a manner known to the UE or implemented in a pseudo-random manner. The benefits to scheduled muting in the partial alignment case can be seen in 3GPP contribution R1-092628. For the simulation results in the example in 3GPP contribution R1-092628, it is assumed that the UE knows whether or not the positioning reference signal is transmitted.

However, in the approved Rel-9 CR 248 R1-094429 applicable to 3GPP specification TS 36.213, muting can be implemented autonomously by the eNB on a subframe basis so that the UE does not know if an eNB on which it wished to take a measurement is muted for a particular positioning subframe. According to the 3GPP specification TS 36.213 (Rel-9): A UE may assume that downlink positioning reference signal energy per resource element (EPRE) is constant across the positioning reference signal (PRS) bandwidth and across all OFDM symbols in a subframe that contain positioning reference signals. Therefore, the eNB is required to maintain constant PRS transmission power across all OFDM over the transmission bandwidth only within one subframe. The PRS transmission power can change from subframe to subframe. This includes the possibility that the eNB transmits PRS on one subframe (PRS “ON”) and mutes on the next (PRS “OFF”) and so on.

In general, the UE may choose to combine multiple PRS measurements for a particular eNB in order to generate an improved measurement. However, with autonomous muting as allowed in TS 36.213 (Rel-9), the UE does not know if PRS are transmitted in a given positioning subframe of an eNB. Thus, the UE does not know whether or not to take a measurement on a particular positioning subframe, or alternatively, if the UE always takes a measurement, if the measurement is valid. Because PRS muting can be implemented on a subframe-by-subframe basis without restriction, the UE must determine prior to any combining whether each PRS measurement is valid or not (i.e., the PRS are transmitted or not). Thus, the UE must implement pre-combining detection of the presence or absence of the PRS. Conversely, if some restrictions were placed on the autonomous muting so that a group of positioning subframes were all muted or all not muted, it would be possible for the UE to combine PRS measurements for this group of subframes prior to making a determination of the presence or absence of the PRS, and this is referred to as post-combining detection. Post-combining detection is always more reliable than pre-combining detection as the signal-to-noise ratio of combined measurements is greater than any of the individual measurements of which it is comprised (assuming appropriate SINR weighting).

It should be apparent that if an invalid measurement (no PRS in the subframe) is combined with valid measurements, the signal-to-noise ratio of the combined measurement with the invalid measurement is degraded relative to the combination excluding the invalid measurement. Conversely, if a valid measurement is combined with other valid measurements, the signal-to-noise ratio of the combined measurement with this valid measurement is improved relative to the combined measurement excluding this valid measurement (assuming appropriate SINR weighting).

The problem of detecting the presence or absence of the PRS in a positioning subframe is further complicated in the partially-aligned case. When positioning support is enabled in the LTE network, Nprs multiple consecutive positioning subframes are configured, where Nprs can be 1, 2, 4, or 6. In the partially-aligned case, the multiple consecutive positioning subframes are used for at least two reasons: (i) so that the PRS measurements can be combined across multiple positioning subframes, and (ii) so that the PRS measurements can be taken on positioning subframes which are interfered with only by other positioning subframes.

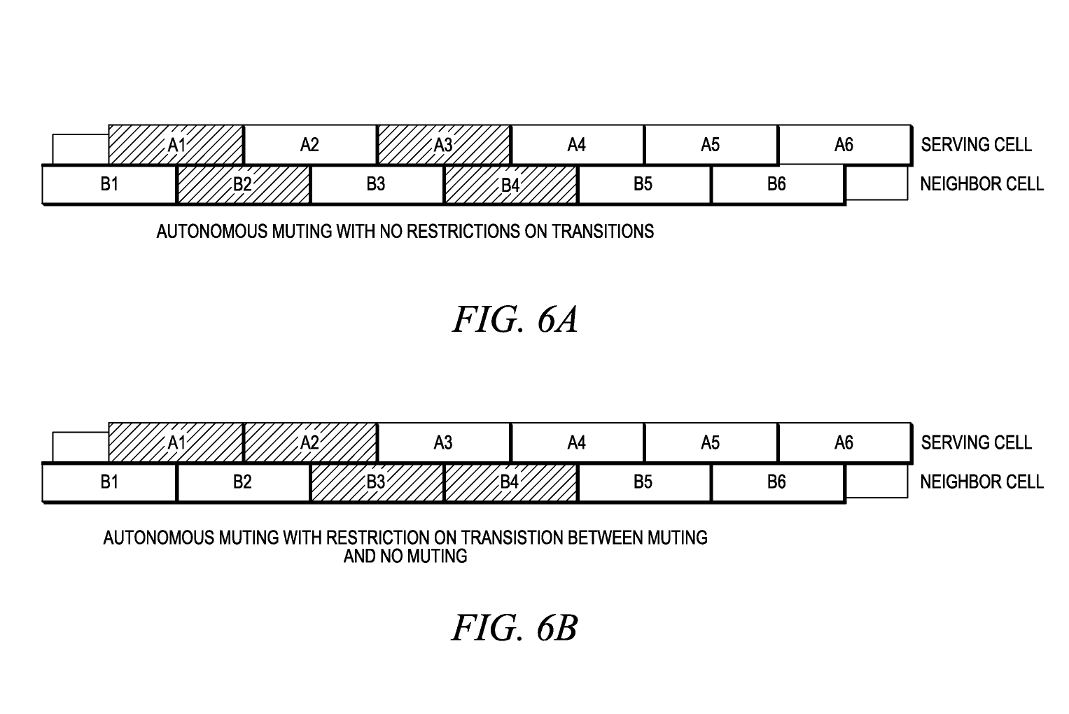

Note that with a maximum subframe offset of 1 subframe between any two base stations, Nprs must be at least 2 to ensure that the positioning subframes of the two eNB's will overlap by at least one full positioning subframe. Suppose for example, that Nprs=2 instead of 6 as in FIG. 6A. The serving eNB transmits subframes A1 and A2 and the neighbor eNB transmits subframes B1 and B2. Since PDSCH (data) is typically not transmitted on positioning subframes to mitigate interference from data transmission to OTDOA measurements, it is desirable to take measurements on only those PRS subframes that overlap with positioning subframes from a different eNB. In this example, it is desirable to take measurements on B2 to obtain the OTDOA for the neighbor eNB. In order that there is at least one full subframe for a neighbor eNB available for OTDOA measurements such that it is interfered by only the positioning subframes from the serving cell, Nprs must be at least 2. If we set Nprs=1, one full subframe would not be guaranteed for the measurement.

With respect to (ii), it should be noted that positioning subframes are sometimes referred to as “low interference subframes,” because only ⅙-th of the resource elements of a given OFDM symbol are occupied in the frequency domain. Thus, when the UE is measuring the PRS in a positioning subframe for a first eNB, it will see less interference from a second eNB if this second eNB transmits a positioning subframe than if this second eNB transmits a normal (non-positioning) subframe that includes PDSCH. However, especially in the partially-aligned case, the UE measuring PRS from the first eNB will still see very significant interference from the positioning subframe of the second eNB if the relative received powers of the signals from the two eNB's are comparable. The interference from the second eNB will be most significant in the event that the second eNB is the serving cell, and the power received from the serving cell is much greater than that received from the first eNB on which the measurement is to be taken.

Consider the example of the partially-aligned case in the example in FIGS. 6A and 6B, in which 6 consecutive positioning subframes (i.e., Nprs=6) are used. In this example, subframes A1 through A6 denote the positioning subframes for the serving cell, while subframes B1 through B6 represent the positioning subframes for a neighboring cell on which the UE will take a TDOA measurement. In FIG. 6A, the serving cell transmits PRS in positioning subframes A1 and A3 and mutes the PRS in subframes A2, A4, A5 and A6 while the neighbor cell transmits PRS in positioning subframes B2 and B4 and mutes the PRS in positioning subframes B1, B3, B5 and B6.

It can be noted that in a synchronous deployment, the subframe boundaries of the two cells would be aligned so that measurements could be taken on subframes B2 and B4 without interference from the serving cell due to PRS. Note, however, that depending on which subframe type—normal or MBSFN—is configured for PRS transmission, there can be interference from the control region of the subframe and from CRS in the non-control region. In this example of partial-alignment, the subframes of the two cells are offset by one-half of a subframe and thus serving cell PRS transmissions in A1 and A3 interfere with measurements taken on the neighbor cell PRS in subframes B2 and B4. Because the serving cell signal is generally very strong, the UE can readily determine that the serving cell transmits PRS in subframes A1, A3, and A5 and not in subframes A2, A4, and A6. Thus, the UE is aware that measurements on the first half of B2 and B4 will see serving cell interference from the PRS transmissions in A1 and A3.

In order to avoid interference from the serving cell, the UE may choose to take OTDOA measurement using only the PRS in the second half of positioning subframes B2 and B4. However, as a result, the problem of determining the presence or absence of the PRS in the neighbor cell positioning subframes has been made more difficult due to the fact that there is now 3 dB less PRS energy to measure. Furthermore, it may not be possible to coherently combine the OTDOA measurements taken on the second-half of B2 and the second half of B4 if the Doppler exceeds some maximum threshold, and it may instead be necessary to combine the measurements non-coherently. If the measurements are combined non-coherently, this will results in an effective combining loss on the order of 2 dB for the resulting combined measurement.

In order to avoid problems such as these, it may be beneficial to place some restrictions on the autonomous muting so that the eNB cannot transition between muting and transmitting the PRS at the boundary between every two positioning subframes (as is currently allowed in the 3GPP specification TS 36.211). In 3GPP contribution R4-094532, the following was proposed:

For the sake of simplicity, it is also proposed that muting periods span either over a half or all consecutive subframes in the positioning occasion when muting applies.

In this disclosure, a different set of restrictions are proposed. In a system with autonomous muting in which Nprs consecutive positioning subframes are used, the following restrictions may be applied:

Restriction 1: For Nprs=2 or 6, the eNB can switch between muting and non-muting only after an even number of consecutive positioning subframes. Thus, for Nprs=2, both positioning subframes in a positioning occasion must be muted or not muted. For Nprs=6, the eNB can either transmit PRS on 2, 4 or 6 of the Nprs positioning subframes, or it can mute the PRS on all Nprs positioning subframes.

Restriction 2: An additional restriction can be that when a eNB transmits PRS, it transmits on only two positioning subframes. For Nprs=2, as before, the eNB can either transmit PRS on both subframes or mute on both. For Nprs=6, the eNB can transmit PRS on 2 of the Nprs positioning subframes and mute on the remainder or alternately it can mute on all of the Nprs positioning subframes.

With the above restrictions, the following can be observed:
1) For both Nprs=2 and Nprs=4, the UE can take OTDOA measurements for a neighbor cell on at least 1 full positioning subframe in a positioning occasion without interference from the serving cell as long as the neighbor cell transmits PRS using a different transmission pattern than the serving cell. For Nprs=2, the UE cannot take an OTDOA measurement for a neighbor cell without serving cell interference if the serving eNB transmits PRS during the given positioning occasion.
2) There are 2 allowed muting patterns for Nprs=2 and 4 allowed muting patterns for Nprs=6.

The UE can choose to take OTDOA measurement for a neighbor cell on PRS subframes when the serving cell is transmitting if one or both of the following conditions are met: It is a synchronous deployment and the serving and neighbor cells use orthogonal patterns; or The neighbor cell received power is comparable to or higher than the serving cell received power thus ensuring that the serving cell interference to OTDOA measurements is small.

In this case, the UE may appropriately make use of the OTDOA measurement (e.g., SINR-weighted combining).

Consider the example in FIG. 6B in which restrictions 1 and 2 are imposed, so that the eNB can only switch the PRS ON/OFF after an even number of positioning subframes within the burst of Nprs consecutive positioning subframes. Note that in this example in which six consecutive positioning subframes are configured, it is guaranteed that whenever the serving cell and the neighbor cell use different muting patterns (and the neighbor cell does not mute all Nprs positioning subframes), it will always be possible to take a measurement on the PRS in at least one full positioning subframe without interference from the serving cell. In this example, there is no interference from the serving cell over the interval of one and one-half positioning subframes consisting of the second half of positioning subframe B3 and all of positioning subframe B4.

Note that this arrangement is efficient from an implementation perspective as it allows the UE to take measurements in the same way as for the synchronous case with Nprs=1. That is, the UE can correlate with an entire positioning subframe, and need not correlate over fractions of a positioning subframe (though it may choose to do so). Thus, to some extent, the same PRS correlator can be used in both the synchronous and partially-aligned cases.

Restriction 1 listed above can be summarized as follows. The serving eNB first configures Nprs consecutive subframes for positioning reference signal transmission. As mentioned earlier, the transmission timing of PRS from the serving and different eNBs are either well aligned (i.e., synchronous) or coarsely aligned (i.e., partially-aligned). Each eNB only transmits PRS in a subset or group of subframes capable of or configured for PRS transmission. The UE receives Nprs consecutive subframes configured for positioning reference signal (PRS) transmission from an eNB such that the transition from transmission of PRS (i.e., on period) to non-transmission of PRS (i.e., off period) or vice-versa within the group of Nprs consecutive subframes can occur only after an even number of subframes 2*k, where k=0, 1, 2, . . . , etc. An on-to-off or off-to-on transition need not occur at every allowed transition point 2*k. For example, two consecutive on periods of 2 subframes each may be allowed. For Nprs=2, the eNB is either transmitting on both subframes or is muting.

The UE may choose to take OTDOA measurements for neighbor cell only when the serving cell is muting. Therefore, the UE has to first determine, based on the signal received from the serving cell, which of Nprs/2 blocks of subframes—where each block comprises 2 consecutive subframes—is muting. Equivalently, the UE can determine over which of the Nprs/2 blocks of subframes the serving eNB is transmitting and take OTDOA measurements for the neighbor cells on a subset of the remainder of the Nprs subframes. Restriction 2 together with Restriction 1 implies that the number of blocks over which PRS transmission is on is equal to 1.

The serving eNB provides assistance data to the UE to facilitate OTDOA measurements. The assistance data can contain the PCID of the neighbor cells, the coarse timing estimate of the neighbor cells relative to the serving cell, the window size around the coarse timing estimate around which the UE is expected to measure OTDOA, the number of consecutive subframes configured for PRS transmission (i.e., Nprs), etc. The assistance data can be transmitted over a system information block (SIB) or over a Radio Resource Control (RRC) message designed for configuring OTDOA measurements. In addition, the serving cell may indicate the autonomous muting status of the network which indicates whether or not cells in a certain geographical location have autonomous muting (i.e., APRT method) enabled. The embodiments in the present disclosure are applicable to the case when APRT method is enabled. Therefore, on receipt of the indication that autonomous muting is enabled by the serving and neighbor base stations, the UE determines that the restrictions on autonomous muting are applicable.

In another embodiment, the eNBs are not allowed to mute on all of the Nprs positioning subframes for Nprs=6. The eNB would be required to always transmit PRS on 2 of the Nprs positioning subframes.

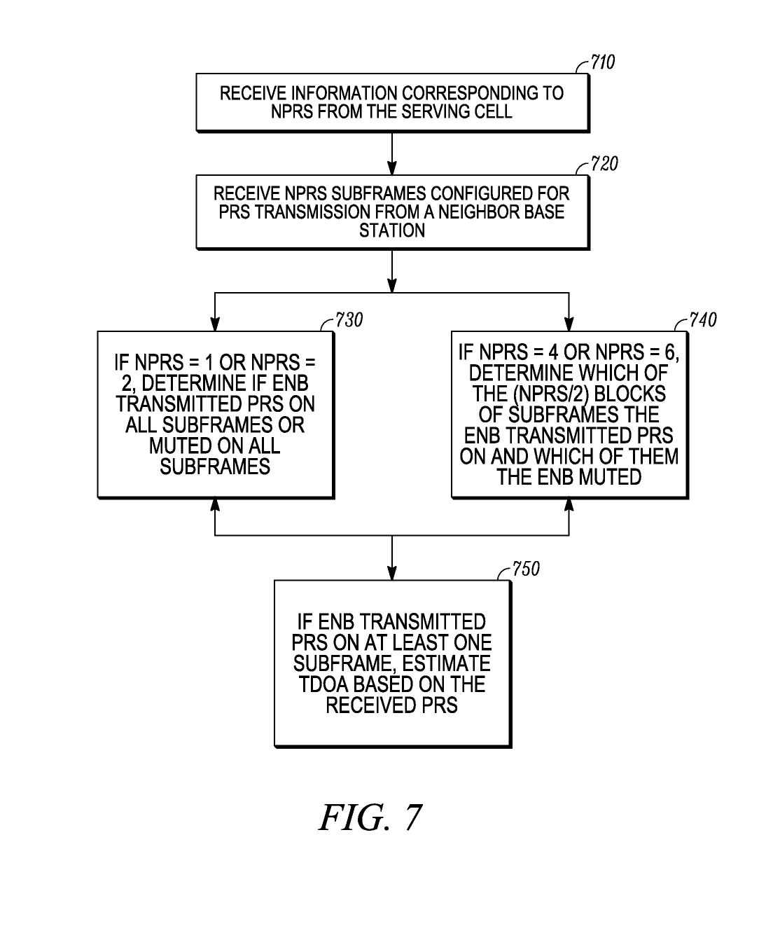

The UE receiver operation can be sequentially captured through the following steps in order to make use of the one or more of the above restrictions placed on autonomous muting. In FIG. 7, at 710, the UE receives information corresponding to Nprs from the serving cell. At 720, the UE receive Nprs subframes configured for PRS transmission from a neighbor base station. At 730, if Nprs=1 or Nprs=2, the UE determines if eNB transmitted PRS on all subframes or muted on all subframes. At 740, if Nprs=4 or Nprs=6, the UE determines which of the (Nprs/2) blocks of subframes the eNB transmitted PRS on and which of them the eNB muted, where each block comprises two consecutive subframes configured for PRS transmission. At 750, if eNB transmitted PRS on at least one subframe, the UE estimates TDOA based on the received PRS and sends an OTDOA report to the serving base station.

In one particular implementation, the UE or mobile terminal receives a transmission from a first base station, wherein the transmission includes a group of Nprs consecutive subframes, where Nprs=2 or Nprs=6. Generally, the group of Nprs consecutive subframes is configured such that a transition between a subframe that does, or does not, include a PRS transmission to a subsequent subframe that does not, or does, include a PRS transmission can occur only after an even number of subframes 2*k, where k=0, 1, 2 . . . . For Nprs=2, all subframes in the group of Nprs consecutive subframes configured either to include a PRS transmission or not to include a PRS transmission. For Nprs=6, the group of Nprs consecutive subframes is configured such that a transition between non-transmission and transmission of PRS on a subframe can occur only at a beginning of even numbered subframes 2*k and transition between transmission and non-transmission of PRS on a subframe can occur only at a beginning of even numbered subframes 2*(k+j), where k=0, 1, 2 and where j=1 to 3−k. In a more particular embodiment, j=1. The mobile terminal then determines an estimated time of arrival of the transmission from the first base station based on a portion of the transmission that includes a PRS transmission.

In one embodiment, the mobile terminal receives a transmission from a second base station indicating whether autonomous muting of the first base station is enabled, the autonomous muting enabling the first base station to mute PRS transmissions in the group of Nprs consecutive subframes. The mobile terminal may also receive a transmission from a second base station indicating the value or Nprs, for example, Nprs is either 2 or 6. The second base station may be a serving base station and the transmission may corresponds to either a system information block or a radio resource control message.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a mobile terminal, the method comprising:
receiving, at the mobile terminal, a transmission from a first base station,
the transmission including a group of Nprs consecutive subframes, where Nprs is a number of subframes constituting the group of consecutive subframes and where Nprs=2 or Nprs=6,
each subframe, of the group of Nprs consecutive subframes, capable of transmitting a positioning reference signal (PRS),
the group of Nprs consecutive subframes configured such that a transition between a subframe that does, or does not, include a PRS transmission to a subsequent subframe that does not, or does, include a PRS transmission can occur only after an even number of subframes 2*k, where k=0, 1, 2 . . . ; and
determining an estimated time of arrival of the transmission from the first base station based on a portion of the transmission that includes a PRS transmission.

2. The method of claim 1 further comprising determining the estimated time of arrival based on determining which Nprs/2 blocks of subframes contain a PRS transmission, wherein each block comprises 2 consecutive subframes.

3. The method of claim 1 further comprising receiving a transmission from a second base station indicating whether autonomous muting of the first base station is enabled, the autonomous muting enabling the first base station to mute PRS transmissions in the group of Nprs consecutive subframes.

4. The method of claim 1 further comprising receiving a transmission from a second base station indicating whether Nprs is either 2 or 6.

5. The method of claim 4, wherein the second base station is a serving base station and the transmission corresponds to either a system information block or a radio resource control message.

6. The method of claim 1 wherein Nprs=6, further comprising receiving a PRS transmission on at least 2 consecutive subframes in the group of Nprs consecutive subframes.

7. The method of claim 6, wherein the second base station is a serving base station and the transmission corresponds to either a system information block or a radio resource control message.

8. The method of claim 1 further comprising determining which of Nprs/2 blocks of subframes received from the first base station include a PRS transmission, wherein each block of subframes comprises two consecutive subframes configured for PRS transmission.

9. A method in a mobile terminal, the method comprising:
receiving, at the mobile terminal, a transmission from a first base station, the transmission including a group of Nprs consecutive subframes, where Nprs is a number of subframes constituting the group of consecutive subframes and where Nprs=6,
each subframe, of the group of Nprs consecutive subframes, capable of transmitting a positioning reference signal (PRS),
the group of Nprs consecutive subframes configured such that a transition between non-transmission and transmission of PRS on a subframe can occur only at a beginning of even numbered subframes 2*k and transition between transmission and non-transmission of PRS on a subframe can occur only at a beginning of even numbered subframes 2*(k+j), where k=0, 1, 2 and where j=1 to 3−k; and
determining a time of arrival of the transmission from the first base station based on a portion of the transmission that includes a PRS transmission.

10. The method of claim 9, where j=1.

11. The method of claim 9 further comprising receiving a transmission from a second base station indicating whether autonomous muting of the first base station is enabled, the autonomous muting enabling the first base station to mute PRS transmissions in the group of Nprs consecutive subframes.

12. The method of claim 9 further comprising receiving a transmission from a second base station indicating whether Nprs is either 2 or 6.

13. The method of claim 12, wherein the second base station is a serving base station and the transmission corresponds to either a system information block or a radio resource control message.

14. The method of claim 9 wherein Nprs=6, further comprising receiving a PRS transmission on at least 2 consecutive subframes in the group of Nprs consecutive subframes.

15. The method of claim 14, wherein the second base station is a serving base station and the transmission corresponds to either a system information block or a radio resource control message.

16. A method in a mobile terminal, the method comprising:
receiving, at the mobile terminal, a transmission from a first base station, the transmission including a group of Nprs consecutive subframes, where Nprs is a number of subframes constituting the group of consecutive subframes and where Nprs=2,
each subframe, of the group of Nprs consecutive subframes, capable of transmitting a positioning reference signal (PRS),
all subframes in the group of Nprs consecutive subframes configured either to include a PRS transmission or not to include a PRS transmission; and
determining a time of arrival of the transmission from the first base station based on the group of Nprs consecutive subframes received when the group of Nprs consecutive subframes include a PRS transmission.

17. A method in a mobile terminal, the method comprising:
receiving, at the mobile terminal, information pertaining to Nprs, which is a number of subframes configured for PRS transmission from a serving base station;
determining that Nprs=1 or Nprs=2 based on the information received from the serving base station;
receiving a signal including Nprs subframes configured for PRS transmission from a neighbor base station;
determining that the neighbor base station transmitted PRS on at least one subframe;
estimating a time of arrival of transmission from the neighbor base station based on the PRS transmitted on the at least one subframe.

18. A method in a mobile terminal, the method comprising:
receiving information pertaining to Nprs, which is a number of subframes configured for PRS transmission from a serving base station, where Nprs=2 or Nprs=6;
receiving a signal including Nprs subframes configured for PRS transmission from a neighbor base station;
determining which of Nprs/2 blocks of subframes received from the neighbor base station include a PRS, where each block of subframes comprises two consecutive subframes configured for PRS transmission;
estimating a time of arrival of the transmission from the neighbor base station based on the PRS transmission.
